(19) United States
(12) Patent Application Publication
(10) Pub. No.: US 2022/0351159 A1
(43) Pub. Date: Nov. 3, 2022

(54) SYSTEM, PROGRAM PRODUCT, AND COMPUTER-IMPLEMENTED METHOD FOR LOADING A LOAN ON AN EXISTING PRE-PAID CARD

(71) Applicant: Metabank, Sioux Falls, SD (US)

(72) Inventors: Scott Galit, New York, NY (US); Trent Sorbe, Brookings, SD (US)

(73) Assignee: Metabank, Sioux Falls, SD (US)

(21) Appl. No.: 17/578,150

(22) Filed: Jan. 18, 2022

Related U.S. Application Data
(63) Continuation-in-part of application No. 13/941,530, filed on Jul. 14, 2013, now Pat. No. 11,227,331.
Application No. 13/941,530 is a continuation of application No. 12/465,306, filed on May 13, 2009, now Pat. No. 8,538,879.
(60) Provisional application No. 61/053,056, filed on May 14, 2008.
(60) Provisional application No. 61/060,559, filed on Jun. 11, 2008.
(60) Provisional application No. 61/082,863, filed on Jul. 23, 2008.

(51) Int. Cl. G06Q 20/06; G06Q 20/34; G07F 7/02; G06Q 40/02; G06Q 20/28; G06Q 20/20; G06Q 20/10; G07F 7/08

(52) U.S. Cl. CPC G06Q 20/06; G06Q 20/342; G07F 7/025; G06Q 40/02; G06Q 20/28; G06Q 20/204; G06Q 20/105; G06Q 40/025; G07F 7/086

(57) ABSTRACT

Embodiments of the present invention provide systems, program products, and methods of loading a loan on a pre-paid card. A bank receives authorization from a lender to credit loan proceeds from the lender to an approved borrower on an existing pre-paid card associated with the pre-paid card processor. Next, the bank credits the loan proceeds to the pre-paid card processor for the existing pre-paid card so that the loan proceeds are released to the approved borrower and are immediately available.

### RELATED APPLICATIONS

This application is a continuation-in-part of and claims priority to and the benefit of U.S. Non-Provisional patent application Ser. No. 13/941,530, by Galit et al, titled “System, Program Product, and Method for Loading a Loan on a Pre-Paid Card,” filed Jul. 14, 2013, which is a continuation of and claims priority to and the benefit of: U.S. Non-Provisional patent application Ser. No. 12/465,306, by Galit et al., titled “System, Program Product, and Method for Loading a Loan on a Pre-Paid Card” filed May 13, 2009, which claims priority to and the benefit of: U.S. Provisional Patent Application Ser. No. 61/053,056, by Galit et al., titled “System, Program Product, and Method for Loading a Loan on a Pre-Paid Card” filed May 14, 2008; U.S. Provisional Patent Application Ser. No. 61/060,559, by Galit et al., titled “Methods, Program Product, and System to Enhance Banking Terms Over Time” filed on Jun. 11, 2008; and U.S. Provisional Patent Application Ser. No. 61/082,863, by Ahlers et al., titled “System, Program Product, and Method For Debit Card and Checking Account Autodraw” filed on Jul. 23, 2008. The contents of U.S. Non-Provisional patent application Ser. Nos. 13/941,530 and 12/465,306 and U.S. Provisional Patent Application Ser. Nos. 61/053,056, 61/060,559, and 61/082,863 are each incorporated herein by reference in their entireties. This application also relates to: U.S. Provisional Patent Application Ser. No. 61/016,213, by Sorbe et al., titled “Transfer Account Systems, Computer Program Products, and Associated Methods” filed on Dec. 21, 2007; U.S. Provisional Patent Application Ser. No. 61/052,454, by Sorbe et al., titled “Transfer Account Systems, Computer Program Products, and Methods to Prioritize Payments from Preselected Bank Account” filed May 12, 2008; U.S. Provisional Patent Application Ser. No. 61/029,975, by Sorbe et al., titled “Methods To Advance Loan Proceeds On Prepaid Cards, Associated Systems and Computer Program Products” filed on Feb. 20, 2008; U.S. Provisional Patent Application Ser. No. 61/042,612, by Ahlers et al., titled “System, Program Product, and Associated Methods to Authorize Draw for Micro-Credit Attached to a Prepaid Card” filed on Apr. 4, 2008; U.S. Provisional Patent Application Ser. No. 61/042,624, by Crowe et al., titled “System, Program Product, and Method to Authorize Draw for Retailer Optimization” filed on Apr. 4, 2008; U.S. Provisional Patent Application Ser. No. 61/032,750, by Ahlers et al., titled “Methods, Program Product, and System for Micro-Loan Management” filed on Feb. 29, 2008, all of which are each incorporated herein by reference in their entireties. This application also relates to: U.S. patent application Ser. No. 12/338,365, by Sorbe et al., titled “Transfer Account Systems, Computer Program Products, and Associated Computer-Implemented Methods” filed on Dec. 18, 2008; U.S. patent application Ser. No. 12/338,402, by Sorbe et al., title “Transfer Account Systems, Computer Program Products, and Associated Computer-Implemented Methods” filed on Dec. 18, 2008; U.S. patent application Ser. No. 12/338,440, by Sorbe et al., titled “Transfer Account Systems, Computer Program Products, and Associated Computer-Implemented Methods” filed on Dec. 18, 2008; U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/389,749, by Sorbe et al., titled “Methods to Advance Loan Proceeds on Prepaid Cards, Associated Systems and Computer Program Products” filed on Feb. 20, 2009; PCT/US09/34692, by Sorbe et al., titled “Methods to Advance Loan Proceeds on Prepaid Cards, Associated Systems and Computer Program Products” filed on Feb. 20, 2009; U.S. patent application Ser. No. 12/417,199, by Ahlers et al., titled “System, Program Product, and Associated Methods to Authorize Draw for Micro-Credit Attached to a Prepaid Card” filed on Apr. 2, 2009; U.S. patent application Ser. No. 12/417,211, by Ahlers et al., titled “System, Program Product, and Associated Methods to Authorize Draw for Micro-Credit Attached to a Prepaid Card” filed on Apr. 2, 2009; PCT/US09/39492, by Ahlers et al., titled “System, Program Product, and Associated Methods to Authorize Draw for Micro-Credit Attached to a Prepaid Card” filed on Apr. 3, 2009; PCT/US09/39504, by Ahlers et al., titled “System, Program Product, and Associated Methods to Authorize Draw for Micro-Credit Attached to a Prepaid Card” filed on Apr. 3, 2009; U.S. patent application Ser. No. 12/417,182, by Crowe et al., titled “System, Program Product, and Method to Authorize Draw for Retailer Optimization” filed on Apr. 2, 2009; PCT/US09/39512, by Crowe et al., titled “System, Program Product, and Method to Authorize Draw for Retailer Optimization” filed on Apr. 3, 2009; U.S. patent application Ser. No. 12/338,684, by Ahlers et al., titled “Computer-Implemented Methods, Program Product, and System for Micro-Loan Management” filed on Dec. 18, 2008; PCT/US08/87660 by Ahlers et al., titled “Computer-Implemented Methods, Program Product, and System for Micro-Loan Management” filed on Dec. 19, 2008; U.S. patent application Ser. No. 12/338,712, by Galit et al., titled “Computer-Implemented Methods, Program Product, and System to Enhance Banking Terms Over Time” filed on Dec. 18, 2008; PCT/US08/87689 by Galit et al., titled “Computer-Implemented Methods, Program Product, and System to Enhance Banking Terms Over Time” filed on Dec. 19, 2008; U.S. patent application Ser. No. 12/417,162, by Ahlers et al., titled “System, Program Product, and Method For Debit Card and Checking Account Autodraw” filed on Apr. 3, 2009; PCT/US09/39495, by Ahlers et al., titled “System, Program Product, and Method For Debit Card and Checking Account Autodraw” filed on Apr. 3, 2009; and U.S. patent application Ser. No. 12/465,277, by Galit et al., titled “System, Program Product, and Computer-Implemented Method for Loading a Loan on a Pre-Paid Card” filed on May 13, 2009, all of which are each incorporated herein by reference in their entireties.

### BACKGROUND

### 1. Field of Invention

The present invention relates generally to the financial service and banking product industries, and, more particularly, to systems, computer program products, and associated methods of providing loan proceeds to a pre-paid card.

### 2. Background

It is recognized that non-traditional short-term lending, including, e.g., payday loans, payday advances, and other short-term cash advances, is an over $20 billion per year industry. Non-traditional loans, however, involve delays and hassles associated with applying for and obtaining the loan prior to the consumer having access to the funds.

In a retail environment, such as a bank branch or a payday loan store, consumers must travel to their location of choice, apply for the loan, and then wait for a decision from the lender. In some cases, the decision is immediate and the consumer is able to leave the retail lender with funds in hand—usually in the form of a negotiable instrument, e.g., a check. In other cases, the decision requires enough time to elapse that the funding takes place on a later date, which may require the consumer to make a second trip to the retail lender to receive proceeds. Both scenarios are inconvenient and costly to the consumer given the time commitment, travel costs (i.e., gas), and the costs of cashing the instrument used to fund the loan. The system is particularly inefficient for return customers whose credit record is already known and who are essentially pre-approved for future borrowing based on past performance. These customers find themselves traveling to the retail lender primarily just to pick up a loan check. The customer typically cashes the check at another location and only then uses the proceeds.

While less common today with the explosion of Internet-based lending, applying for credit by mail or by telephone is still the most popular means by which consumers obtain credit cards. Here, the consumer forwards application information to the lender. Once received, the lender underwrites and makes the credit decision. If approved, the lender must order a credit card with the consumers personalized information (name and account number on the card). This process can take two to six weeks in most cases, and as a result, is inconvenient at best and useless at worst, especially for consumers in need of loan funds immediately.

Online payday lending, peer-to-peer (also known as person-to-person or P2P) lending, and even traditional bank lending has grown rapidly in the last 8 to 10 years. The typical model involves a consumer submitting various pieces of personal information via a secure website that the lender will use to grant credit. In most cases, the decision to grant credit is immediate (with the exception of P2P auction-style borrowing). The funding of the loan, however, is still delayed. In some cases, the consumer can have loan proceeds deposited into a bank account via the Automated Clearing House (ACH). As understood by those skilled in the art, Automated Clearing House (ACH) is the name of an electronic network for financial transactions in the United States, regulated by the Federal Reserve. Alternately, the funds are delivered to the customer through the mail, usually in the form of a negotiable instrument, such as a check. For those applying for credit cards, they must still wait to access the line of credit until their card arrives 2 to 6 weeks later.

It is known that access to proceeds from a negotiable instrument, such as a check, can be delayed for processing, i.e., waiting for the check to clear, particularly when the proceeds check is drawn on a non-local bank. In addition, such access can generate fees, e.g., a check-cashing fee.

### SUMMARY OF INVENTION

In view of the foregoing, Applicants have recognized one or more sources of many of these problems and provides enhanced embodiments of methods, e.g., computerized methods, of loading loan proceeds to a pre-paid card, and associated systems and computer program products. According to an embodiment of the present invention, a bank receives authorization from a lender to credit loan proceeds from the lender to an approved borrower on a pre-paid card issued by or associated with a pre-paid card processor so that release of the loan proceeds is pending an activation of a pre-paid card. Next, the bank receives notice of an activation of a prepaid card issued by or associated with the pre-paid card processor responsive to an activation request on behalf of the approved borrower. Then the bank credits the pending loan proceeds to the pre-paid card processor for the activated pre-paid card so that the loan proceeds are released to the approved borrower and are immediately available.

According to another embodiment of the present invention, a bank receives authorization from a lender to credit loan proceeds from the lender to an approved borrower on an existing pre-paid card issued by or associated with the pre-paid card processor. Then the bank credits the loan proceeds relatively instantaneously to the pre-paid card processor for the existing pre-paid card so that the loan proceeds are released to the approved borrower and are immediately available.

Other embodiments of the present invention include determining whether the borrower has an existing pre-paid card capable of accepting the loan proceeds. As part of the loan approval process, for example, a borrower can be asked to provide existing pre-paid information to the lender. The lender can ask the bank to verify that an existing pre-paid card is capable of accepting the loan proceeds. In addition, the lender can ask the bank to suggest an existing prepaid card associated with the borrower to accept the loan proceeds. Alternately, the bank can determine that a new pre-paid card is necessary.

To borrowers, benefits of the embodiments of the present invention include convenience of time and place. The convenience of time includes being able to access loan proceeds immediately after the activation of a pre-paid card, without waiting two to six weeks for the arrival of a customized credit card and without the delays, hassles, and cost associated with handling a negotiable instrument, such as, for example, a check. In addition, if the borrower already has a pre-paid card from the pre-paid card processor, the convenience of time includes having access to loan proceeds through the pre-paid card relatively immediately. Also, the embodiments of the present invention, for example, can be implemented around the clock, 24 hours a day, on weekends and holidays, outside of traditional banking hours and even outside of typical extended retailer hours of a payday advance lender. The convenience of place includes being able to access loan proceeds at, for example, thousands of locations nationwide where pre-paid cards are sold. In addition, if the borrower already has a pre-paid card from the pre-paid card processor, the convenience of place includes the borrower being able to apply for a loan and access the loan proceeds over the phone or Internet, without needing to go anywhere.

To lenders, benefits of the embodiments of the present invention include the ability to distribute loan proceeds quickly and electronically, without the need for an expensive bricks-and-mortar presence. The features of the embodiments of the present invention enable lenders to attract new customers and expand into new markets, both geographically and demographically. For example, under embodiments of the present invention, a traditional regional lender can now operate nationwide. For example, under embodiments of the present invention, traditional lenders can now compete directly with payday lenders in terms of convenience—without having to expand their retail presence.

Embodiments of the present invention include a system of loading loan proceeds to a pre-paid card. The system includes a bank computer communicating through an electronic communications network with a lender computer. The lender computer is positioned to approve a loan request from a borrower and authorize the bank computer to credit proceeds of a loan on a pre-paid card. The system also includes a pre-paid card processor computer in communication with the bank computer through an electronic communications network. The pre-paid card processor computer is positioned to notify the bank computer of an activation of a pre-paid card. The system further includes a computer program product associated with the bank computer, stored on a tangible computer memory media, and operable on a computer, the computer program product comprising a set of instructions that, when executed by the computer, cause the computer to perform various operations. The operations can include receiving authorization by the bank computer from the lender computer to credit loan proceeds from the lender to the approved borrower on a pre-paid card issued by or associated with the pre-paid card processor so that release of the loan proceeds is pending an activation of a pre-paid card. The operations can also include receiving notice of an activation of a pre-paid card issued by or associated with the pre-paid card processor responsive to an activation request on behalf of the approved borrower and crediting the pending loan proceeds by the bank computer to the pre-paid card processor for the activated pre-paid card so that the loan proceeds are released to the approved borrower and are immediately available.

Embodiments of the present invention include a computer program product, stored on a tangible computer memory media, operable on a computer, the computer program product comprising a set of instructions that, when executed by the computer, cause the computer to perform various operations. The operations include receiving authorization by a bank from a lender to credit loan proceeds from the lender to an approved borrower on a pre-paid card issued by or associated with a pre-paid card processor so that release of the loan proceeds is pending an activation of a pre-paid card. The operations further include receiving notice of an activation of a pre-paid card issued by or associated with the pre-paid card processor responsive to an activation request on behalf of the approved borrower. The operations also include crediting the pending loan proceeds by the bank to the pre-paid card processor for the activated pre-paid card so that the loan proceeds are released to the approved borrower and are immediately available.

In addition, embodiments of the present invention include systems, program products, and associated methods of loading loan proceeds to a pre-paid card as will be understood by those skilled in the art.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic diagram of loading loan proceeds on a pre-paid card according to an embodiment of the present invention;

FIG. 2 is a schematic diagram of loading loan proceeds on a pre-paid card according to an embodiment of the present invention;

FIG. 3 is a schematic diagram of loading loan proceeds on a pre-paid card according to an embodiment of the present invention;

FIG. 4 is a schematic diagram of loading loan proceeds on a pre-paid card according to an embodiment of the present invention;

FIG. 5 is a schematic block diagram of a system of loading loan proceeds on a prepaid card according to an embodiment of the present invention;

FIG. 6 is a flow diagram of a method of loading loan proceeds on a pre-paid card according to an embodiment of the present invention;

FIG. 7 is a flow diagram of another method of loading loan proceeds on a pre-paid card according to another embodiment of the present invention;

FIG. 8 is a schematic diagram of a computer server having a computer program product stored in memory thereof according to an embodiment of the present invention;

FIG. 9 is a schematic diagram of another computer server having another computer program product stored in memory thereof according to another embodiment of the present invention;

FIG. 10 is a schematic diagram of a computer program product according to an embodiment of the present invention;

FIG. 11 is respective front and back plan views of a prepaid card according to an embodiment of the present invention according to an embodiment of the present invention;

FIG. 12 is a flow diagram of a method of loading loan proceeds on a pre-paid card according to an embodiment of the present invention;

FIG. 13 is a schematic diagram of a computer server having a computer program product stored in memory thereof according to an embodiment of the present invention;

FIG. 14 shows methods available for exemplary prepaid card processors in the prior art;

FIG. 15 shows a software architecture, according to an embodiment;

FIG. 16 shows a computer-implemented method of advancing loan proceeds on a prepaid card, according to an embodiment;

FIG. 17 shows a system to advance loan proceeds on a prepaid card, according to an embodiment;

FIG. 18 shows a data flow between various modules, according to an embodiment; and

FIG. 19 shows a computer program product, according to an embodiment.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

Embodiments of the present invention provide various systems, program products, and methods, e.g., computerized methods, of loading a loan on a pre-paid card. According to an embodiment of the present invention, a bank, i.e., a bank computer, receives authorization from a lender, i.e., a lender computer, to credit loan proceeds from the lender to an approved borrower on a pre-paid card issued by or associated with a pre-paid card processor so that release of the loan proceeds is pending an activation of a pre-paid card. Next, the bank computer receives notice of an activation of a pre-paid card issued by or associated with the pre-paid card processor responsive to an activation request on behalf of the approved borrower. Then the bank computer credits the pending loan proceeds to the pre-paid card processor, i.e., a pre-paid processor computer, for the activated pre-paid card so that the loan proceeds are released to the approved borrower and are immediately available to thereby convert the pre-paid card into a loan delivery apparatus. Advantageously, the loan request and authorization process can occur over the Internet or through a telephone conversation, and the pre-paid card can be purchased at, for example, numerous retail outlets. An activation request for the pre-paid card can include, for example, the retailer or the borrower as understood by those skilled in the art.

According to another embodiment of the present invention, a bank computer receives authorization from a lender computer to credit loan proceeds from the lender to an approved borrower on an existing pre-paid card issued by or associated with the pre-paid card processor. Then the bank computer credits the loan proceeds relatively instantaneously to the pre-paid card processor computer for the existing pre-paid card so that the loan proceeds are released to the approved borrower and are immediately available. Advantageously, the loan request and authorization process can occur over the Internet or through a telephone conversation, resulting in loan proceeds being immediately available without delays or the borrower having to travel to a retail lender.

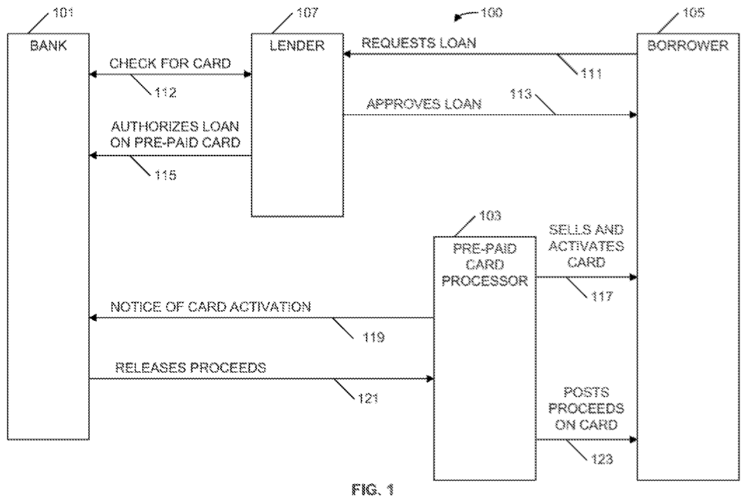

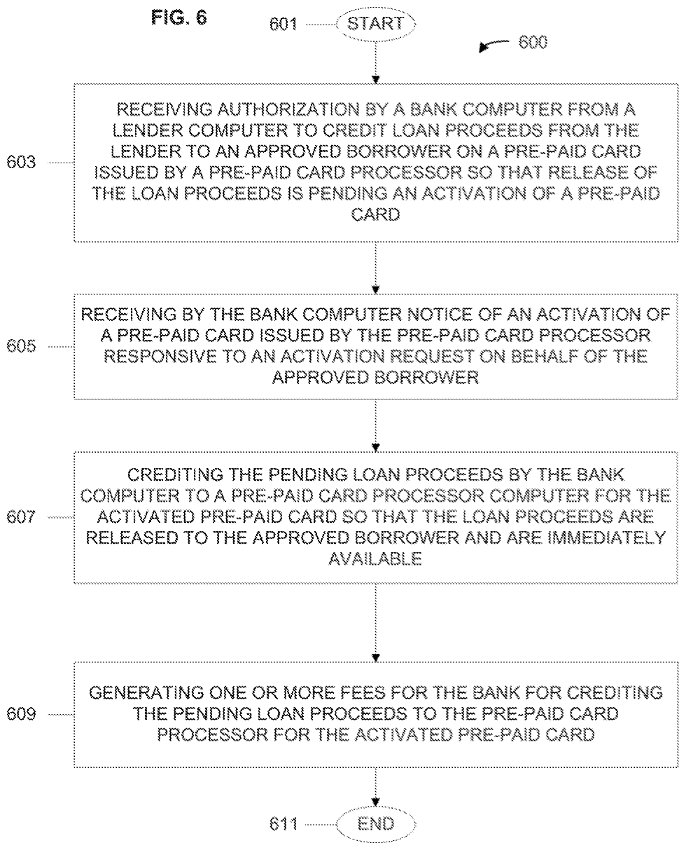

As illustrated in FIGS. 1 and 6, embodiments of the present invention provide, for example, for a method, e.g., a computer-implemented method, 100, 600 of loading loan proceeds to a pre-paid card. The computer-implemented method includes a borrower 105 requesting a loan 111 from a lender 107 and the lender 107 approving the loan 113 to the borrower 105. As part of the loan approval process, the lender 107 can communicate with the bank 101 to check for a pre-paid card 112 for the borrower to either suggest or verify an existing pre-paid card for the borrower 105 or determine that a new pre-paid card is necessary. Next, the computer-implemented method 100, 600 includes the bank receiving authorization in a first computer process from the lender to credit loan proceeds from the lender 107 to the approved borrower 105 on a pre-paid card issued by or associated with the pre-paid card processor 103 so that release of the loan proceeds is pending an activation of a pre-paid card 115, 603. The computer-implemented method can also include the borrower 105 purchasing a pre-paid card from a retailer. The method also includes the borrower 105 (or the retailer or other entity on behalf on the borrower 105) requesting activation of the pre-paid card 117 by the pre-paid card processor 103. The computer-implemented method 100, 600 includes the bank 101 receiving in a second computer process notice of an activation of a pre-paid card issued by or associated with the prepaid card processor responsive to an activation request on behalf of the approved borrower 119, 605. The computer-implemented method 100, 600 includes the bank crediting the pending loan proceeds in a third computer process to the pre-paid card processor for the activated pre-paid card responsive to the received authorization from the first computer process and the received notice of activation from the second computer process so the loan proceeds are released to the approved borrower and are immediately available 121, 607 to thereby convert the pre-paid card into a loan delivery apparatus. The method includes the pre-paid card processor 103 posting the loan proceeds to the pre-paid card 123 as understood by those skilled in the art. The method can also include generating one or more fees for the bank for crediting the pending loan proceeds to the pre-paid card processor for the activated pre-paid card 609. The generated fees are to be paid by the lender 107, the approved borrower 105, or both.

According to other embodiments of the present invention, loan proceeds are available to the approved borrower 105 through the pre-paid card after a delay of one-half of one second to one minute after receiving notice of the activation of the pre-paid card. That is, embodiments of the present invention impose a delay having a range of between one-half of one second and one minute.

According to other embodiments of the present invention, the notice of the activation of the pre-paid card issued by or associated with the pre-paid card processor includes information identifying the approved borrower 105 and the pre-paid card 50 (see, e.g., FIG. 11). Pre-paid cards 50 typically include a unique 16-digit account number 54 as understood by those skilled in the art. The notice of the activation of the pre-paid card from the pre-paid card processor provides the bank with information identifying the pre-paid card, e.g., the 16-digit card number or account number, and information identifying the approved borrower, e.g., the name of the borrower, social security number, address, or other information as understood by those skilled in the art so that the bank can match the pending loan proceeds to the newly activated pre-paid card. In addition, the notice of the activation of the pre-paid card can include a flag, or other designation as understood by those skilled in the art, that the cardholder requested the activation of the pre-paid card in order to access pending loan proceeds.

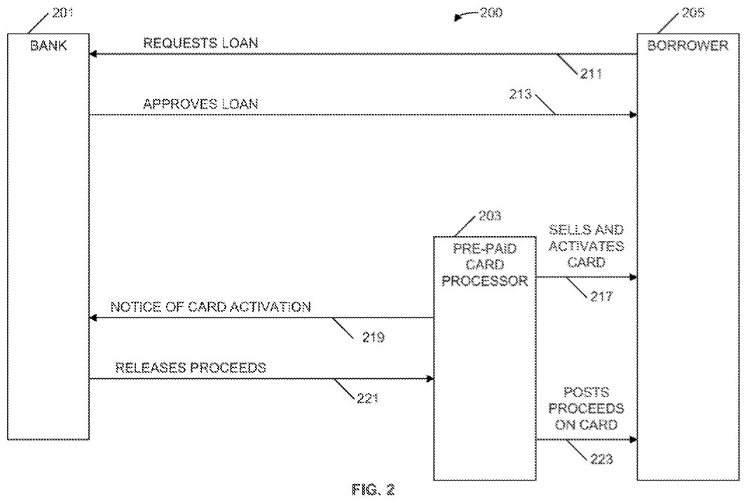

As illustrated in FIG. 2, the lender and the bank 201 can be the same financial institution or affiliated financial institutions. That is, rather than acting as an intermediary between a lender and the pre-paid card processor, the bank 201 can approve loans 213, authorize the credit of loan proceeds to an approved borrower on a pre-paid card, receive notice of an activation of a pre-paid card 219, and credit the pending loan proceeds to the pre-paid card processor for the activated pre-paid card so that the loan proceeds are released to the approved borrower and are immediately available 221. Thus, a bank 201, acting as a lender, can approve a loan and wait for an activation of a pre-paid card to credit the pending loan proceeds, according to embodiments of the present invention. That is, the bank computer converts loan request data from the borrower into a value associated with the pre-paid card. In other embodiments, the bank and the pre-paid card processor can be the same financial institution or affiliated financial institutions so that the bank computer is positioned to approve or reject a transaction using the loan proceeds on the pre-paid card as payment as understood by those skilled in the art. That is, the bank computer can convert loan data into transaction data responsive to a card reader device reading data from the prepaid card and modifying the data to include point of sale data.

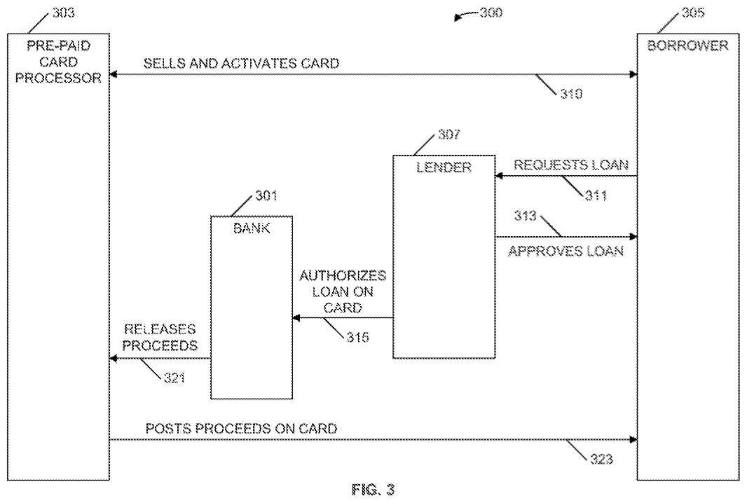

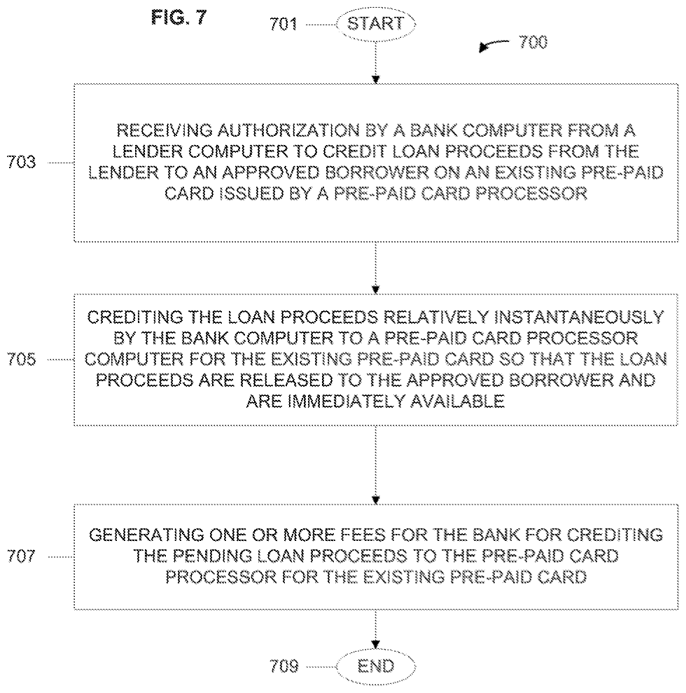

As illustrated in FIGS. 3 and 7, embodiments of the present invention provide, for example, for another computer-implemented method 300, 700 of loading loan proceeds to a prepaid card. The computer-implemented method 300, 700 includes a pre-paid card processor 303 issuing and activating a pre-paid card 310 to a borrower 305. As understood by those skilled in the art, these steps can occur significantly before, e.g., years before, the remaining steps in the method. The computer-implemented method further includes the borrower 305 requesting a loan 311 from a lender 307 and the lender 307 approving the loan 313 to the borrower 305. Next, the computer-implemented method 300, 700 includes the bank 301 receiving authorization from the lender 307 to credit loan proceeds from the lender 307 to the approved borrower 305 on an existing pre-paid card issued by or associated with the pre-paid card processor 303 so that release of the loan proceeds is pending an activation of a pre-paid card 315, 703. The computer-implemented method 300, 700 then includes the bank 301 crediting the loan proceeds to the prepaid card processor for the existing pre-paid card so that the loan proceeds are released to the approved borrower and are immediately available 321, 705. The computer-implemented method includes the pre-paid card processor 303 posting the loan proceeds to the pre-paid card 323 as understood by those skilled in the art. The method can also include generating one or more fees for the bank for crediting the pending loan proceeds to the pre-paid card processor for the existing pre-paid card 707. The generated fees are to be paid by the lender 307, the approved borrower 305, or both.

According to other embodiments of the present invention, loan proceeds are available to the approved borrower 305 through the pre-paid card 50 after a delay of one-half of one second to one minute after receiving authorization by the bank from the lender to credit loan proceeds from the lender to the approved borrower on the existing pre-paid card. That is, embodiments of the present invention impose a delay having a range of between one-half of one second and one minute.

According to other embodiments of the present invention, the authorization received by the bank includes information identifying the existing pre-paid card 50, such as, e.g., the unique 16-digit card number or account number 54. This identifying information allows the bank to match the pending loan proceeds to the existing pre-paid card as understood by those skilled in the art. According to embodiments of the present invention, this pre-paid card information can originate with the borrower or from a suggestion by the bank as part of the loan request process as understood by those skilled in the art.

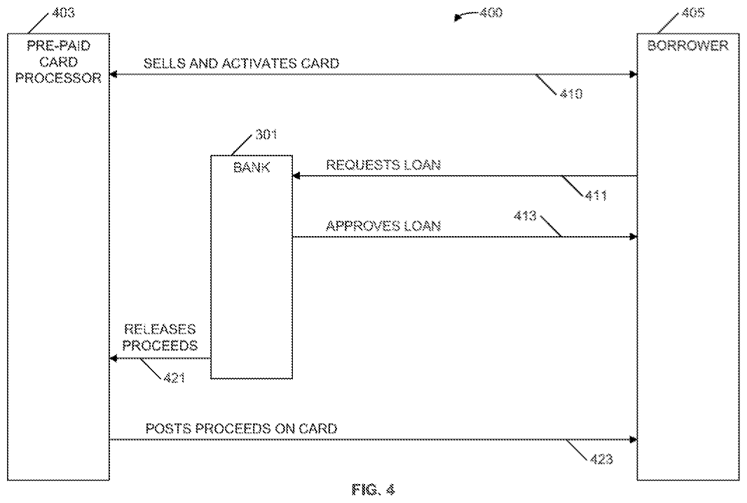

As illustrated in FIG. 4, the lender and the bank 301 can be the same financial institution or affiliated financial institutions. That is, rather than acting as an intermediary between a lender and the pre-paid card processor 403, the bank 401 can approve loans 413, authorize the credit of loan proceeds to an approved borrower on an existing pre-paid card, and credit the loan proceeds to the pre-paid card processor for the existing pre-paid card so that the loan proceeds are released to the approved borrower and are immediately available 421. Accordingly, the bank computer can converts loan request data from the borrower into a value associated with the pre-paid card. In other embodiments, the bank and the pre-paid card processor can be the same financial institution or affiliated financial institutions so that the bank computer is positioned to approve or reject a transaction using the loan proceeds on the pre-paid card as payment as understood by those skilled in the art. That is, the bank computer can convert loan data into transaction data responsive to a card reader device reading data from the prepaid card and modifying the data to include point of sale data.

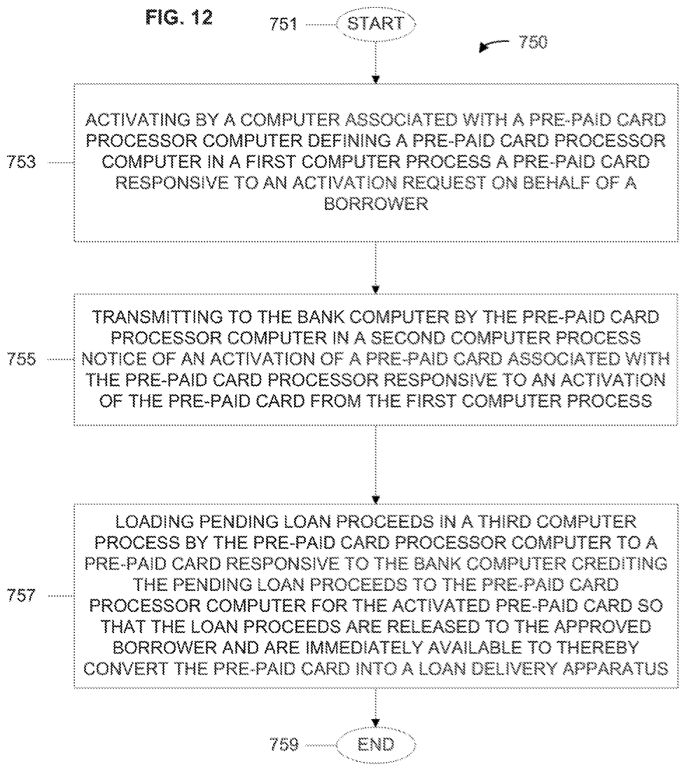

As illustrated in FIG. 12, embodiments of the present invention include, for example, a computer-implemented method of loading loan proceeds to a pre-paid card. The computer-implemented method can include activating by a computer associated with a pre-paid card processor computer defining a pre-paid card processor computer in a first computer process a pre-paid card responsive to an activation request on behalf of a borrower 753. The computer-implemented method can include transmitting to a bank computer by the pre-paid card processor computer in a second computer process notice of an activation of a pre-paid card associated with the pre-paid card processor responsive to an activation of the pre-paid card from the first computer process 755. The computer-implemented method can include loading pending loan proceeds in a third computer process by the pre-paid card processor computer to a pre-paid card responsive to the bank computer crediting the pending loan proceeds to the pre-paid card processor computer for the activated pre-paid card so that the loan proceeds are released to the approved borrower and are immediately available to thereby convert the pre-paid card into a loan delivery apparatus 757. The operation of loading pending loan proceeds by the pre-paid card processor computer to a pre-paid card can also include changing a physical structure of the prepaid card, e.g., a magnetic stripe 58, to reflect a presence of funds sufficient up to a specified amount for purchase of goods or services.

To borrowers, benefits of the embodiments of the present invention include convenience of time and place. The convenience of time includes being able to access loan proceeds immediately after the activation of a pre-paid card, without waiting two to six weeks for the arrival of a customized credit card and without the delays and hassles associated with handling a negotiable instrument, such as, for example, a check. In addition, if the borrower already has a pre-paid card from the pre-paid card processor, the convenience of time includes having access to loan proceeds through the pre-paid card relatively immediately. Also, the embodiments of the present invention, for example, can be implemented around the clock, 24 hours a day, on weekends and holidays, outside of traditional banking hours and even outside of typical extended retailer hours of a payday advance lender. The convenience of place includes being able to access loan proceeds at thousands of locations nationwide where pre-paid cards are sold. In addition, if the borrower already has a pre-paid card from the pre-paid card processor, the convenience of place includes the borrower being able to apply for a loan and access the loan proceeds over the phone or Internet, without needing to go anywhere.

To lenders, benefits of the embodiments of the present invention include the ability to distribute loan proceeds quickly and electronically, without the need for an expensive bricks and mortar presence. The features of the embodiments of the present invention enable lenders to attract new customers and expand into new markets, both geographically and demographically.

According to other embodiments of the present invention, the approved borrower purchases the pre-paid card issued by or associated with the pre-paid card processor at a retailer. Therefore, thousands of locations, for example, can be available for the borrower to obtain a prepaid card issued by or associated with the pre-paid card processor as understood by those skilled in the art.

According to other embodiments of the present invention, the approved borrower and the lender have no business relationship prior to the loan transaction including the authorization from the lender to credit loan proceeds to the approved borrower. Therefore, embodiments of the present invention provide for a first-time borrower, or a borrower using a lender for the first time, as understood by those skilled in the art. That is, no pre-existing relationship, prior to the loan, is necessary.

Therefore, embodiments of the present invention feature numerous convenient approaches to request a loan or activate a pre-paid card. According to embodiments of the present invention, for example, receiving authorization by a bank from a lender to credit loan proceeds from the lender to an approved borrower on a pre-paid card issued by or associated with a pre-paid card processor is responsive to a loan request by the borrower using one or more of the following: Internet technology, a touchtone telephone, a secure website, a telephone conversation with an interactive voice response unit (IVRU), a telephone conversation with a customer service representative, and a mobile phone. According to other embodiments of the present invention, for example, the activation of a pre-paid card issued by or associated with the pre-paid card processor responsive to an activation request from the approved borrower includes using one or more of the following: Internet technology, a touchtone telephone, a secure website, a telephone conversation with an interactive voice response unit (IVRU), a telephone conversation with a customer service representative, and a mobile phone.

According to other embodiments of the present invention, the bank and the pre-paid card processor can be the same financial institution or affiliated financial institutions. That is, a bank can issue and manage pre-paid cards. According to other embodiments of the present invention, the bank can be a federally-chartered bank subject to federal banking laws and regulations and not subject to state banking laws and regulations. As understood by those skilled in the art, a federally-chartered financial institution can operate in every state with a consistent implementation nationally rather than a state-by-state approach.

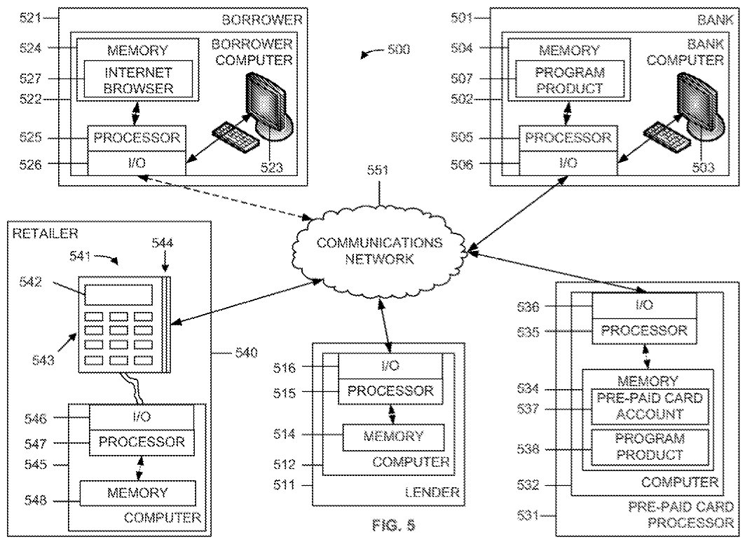

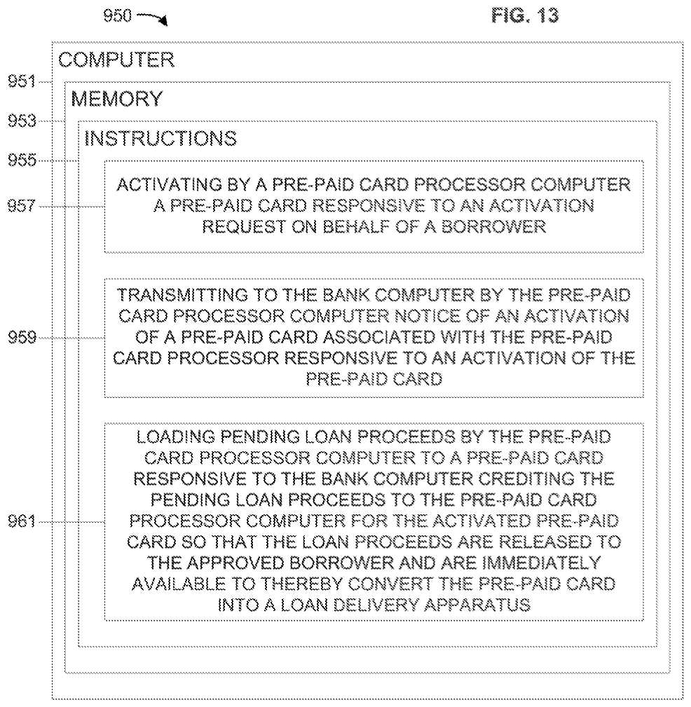

As illustrated in FIG. 5, embodiments of the present invention include a system 500 of loading loan proceeds to a pre-paid card. The system 500 can include a computer associated with a bank 501 defining a bank computer 502. The bank computer 502 can include, for example, a display 503; memory 504, such as, computer readable media; one or more processors 505, and input-output I/O devices 506. The memory 504 of the bank computer 502 can include program product 507 as described herein. The system 500 can include a computer associated with a lender 511 defining a lender computer 512. The lender computer 512 can include, for example, memory 514, such as, computer readable media; one or more processors 515, and input-output I/O devices 516. The memory 516 of the lender computer 502 can include program product to receive loan requests and borrower data; to approve (or reject) loans; and to communicate to the bank computer 502. The system 500 can include a computer associated with a lender 511 defining a lender computer 512. The lender computer 512 can include, for example, memory 514, such as, computer readable media; one or more processors 515, and input-output I/O devices 516. The lender computer 512 can be in communication with the bank computer 502 through an electronic communications network 551 and positioned to approve a loan request from a borrower 521 and to authorize the bank computer 502 to credit proceeds of the loan on a pre-paid card 50. The system 500 can include a computer associated with a pre-paid card processor 531 defining a pre-paid card processor computer 532. The pre-paid card processor computer 532 can include, for example, memory 534, such as, computer readable media; one or more processors 535, and input-output I/O devices 536. The pre-paid card processor computer 532 can include program product 538 as described herein (see, e.g., FIG. 13) and a pre-paid card account 537 as understood by those skilled in the art. The pre-paid card processor computer 532 can be in communication with the bank computer 502 through an electronic communications network 551 and positioned to notify the bank computer 502 of an activation of a pre-paid card 50.

The system 500 further includes program product 507 associated with the bank computer 502, stored on a tangible computer memory media 504, and operable on a computer, the program product comprising a set of instructions that, when executed by the computer, cause the computer to perform various operations. According to an embodiment of the present invention, the operations include receiving authorization by the bank computer 502 from the lender computer 512 to credit loan proceeds from the lender 511 to the approved borrower 521 on a pre-paid card 50 issued by or associated with the pre-paid card processor 531 so that release of the loan proceeds is pending an activation of a pre-paid card. The operations further include receiving notice of an activation of a pre-paid card issued by or associated with the pre-paid card processor computer 532 responsive to an activation request on behalf of the approved borrower 521. The operations also include crediting the pending loan proceeds by the bank computer 502 to the pre-paid card processor 531 for the activated pre-paid card so the loan proceeds are released to the approved borrower 521 and are immediately available to thereby convert the prepaid card into a loan delivery apparatus. According to another embodiment of the present invention, the operations include receiving authorization by the bank computer 502 from the lender computer 512 to credit loan proceeds from the lender 511 to the approved borrower 521 on an existing pre-paid card 50 issued by or associated with the pre-paid card processor 531, and crediting the loan proceeds relatively instantaneously by the bank computer 502 to the pre-paid card processor computer 532 for the existing pre-paid card so that the loan proceeds are released to the approved borrower 521 and are immediately available.

The system 500 can also include a computer associated with a borrower 521 defining a borrower computer 522. The borrower computer 522 can include, for example, a display 523; memory 524, such as, computer readable media; one or more processors 525; and input-output I/O devices 526. The borrower computer 522 can include an Internet browser 527 as understood by those skilled in the art, a computer application used for accessing sites or information on a network. The borrower computer 522 can be positioned to request a loan from the lender computer 512, communicating through the electronic communications network 551.

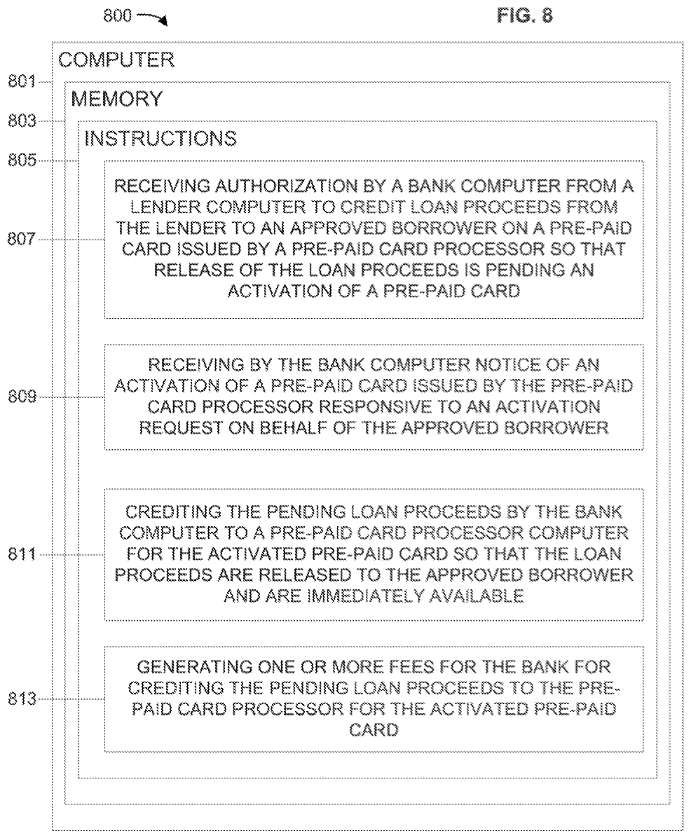

As illustrated in FIG. 8, embodiments of the present invention include, for example, a computer program product 800, stored on a tangible computer memory media 803, operable on a computer 801, the computer program product 800 comprising a set of instructions 805 that, when executed by the computer, cause the computer to perform various operations. The operations can include receiving authorization by a bank computer from a lender computer to credit loan proceeds from the lender to an approved borrower on a pre-paid card issued by or associated with a pre-paid card processor so that release of the loan proceeds is pending an activation of a pre-paid card 807. The operations can further include receiving by the bank computer notice of an activation of a pre-paid card issued by or associated with the pre-paid card processor responsive to an activation request on behalf of the approved borrower 809. The operations can also include crediting the pending loan proceeds by the bank computer to the pre-paid card processor computer for the activated pre-paid card so that the loan proceeds are released to the approved borrower and are immediately available 811 to thereby convert the pre-paid card into a loan delivery apparatus. The operations can also include generating one or more fees for the bank for crediting the pending loan proceeds to the pre-paid card processor for the activated prepaid card 813.

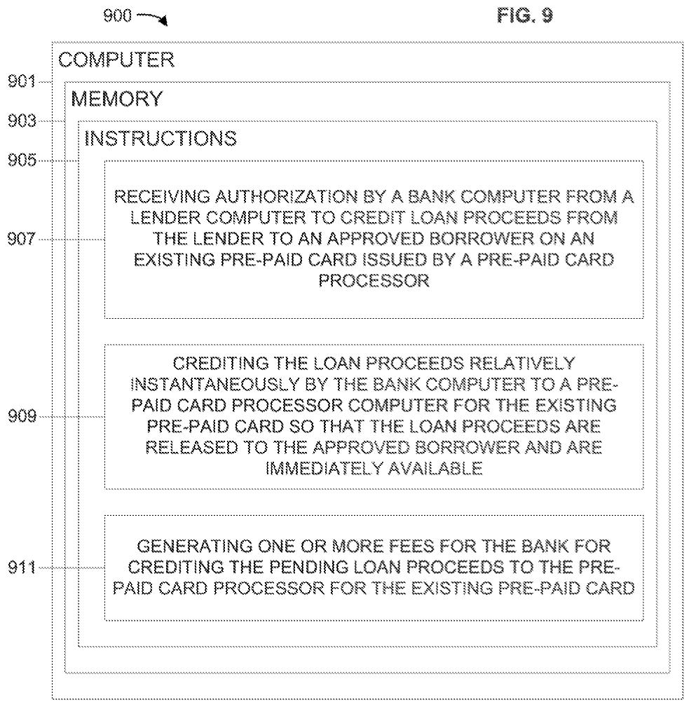

As illustrated in FIG. 9, embodiments of the present invention include, for example, a computer program product 900, stored on a tangible computer memory media 903, operable on a computer 901, the computer program product 900 comprising a set of instructions 905 that, when executed by the computer, cause the computer to perform various operations. The operations can include receiving authorization by a bank computer from a lender computer to credit loan proceeds from the lender to an approved borrower on an existing pre-paid card issued by or associated with a pre-paid card processor 907. The operations can further include crediting the loan proceeds relatively instantaneously by the bank computer to the pre-paid card processor computer for the existing pre-paid card so that the loan proceeds are released to the approved borrower and are immediately available 909. The operations can also include generating one or more fees for the bank for crediting the loan proceeds to the pre-paid card processor for the existing pre-paid card 911.

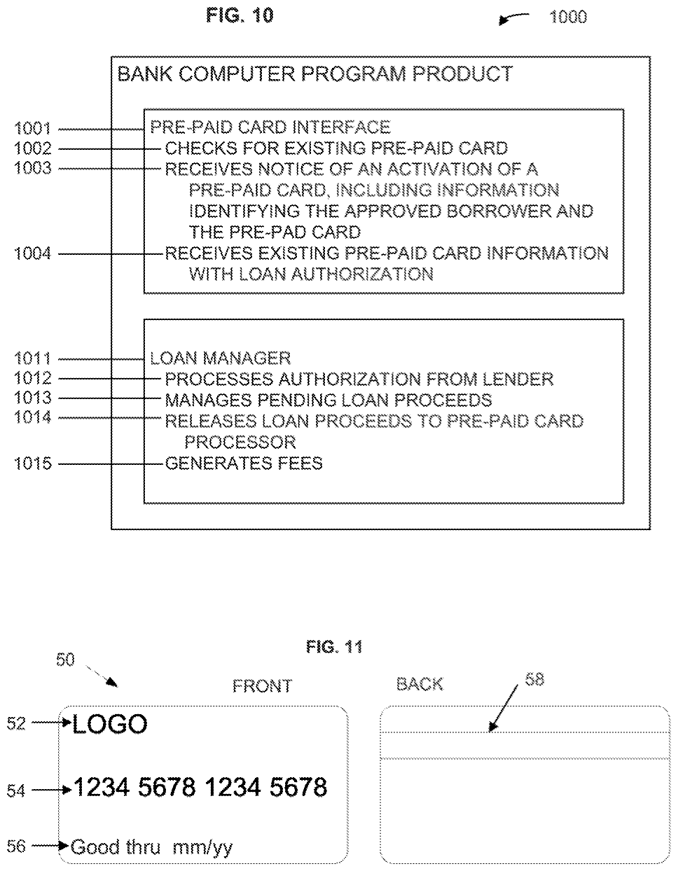

Embodiments of the present invention provide, for example, a computer program product 1000 associated with a bank computer implemented in modules or components, as illustrated in FIG. 10. A pre-paid card interface component 1001 of a computer program product 1000 can check for a pre-paid card for the borrower 1001 to either suggest or verify an existing pre-paid card for the borrower or determine that a new pre-paid card is necessary as part of the loan approval process. The pre-paid card interface component 1001 can also receive and process notice of an activation of a pre-paid card, including information identifying the approved borrower and the pre-paid card 1003, and receive existing pre-paid card information 1004 as understood by those skilled in the art. In addition, a loan manager module 1011 can process authorizations from lenders 1012, manage pending loan proceeds 1013, credit loan proceeds to a pre-paid card processor 1014 for an activated or existing pre-paid card, generate fees 1015, and other associated tasks as understood by those skilled in the art. Other architectures and organizations will be understood by those skilled in the art to be included within the embodiments of the present invention. Computer program products can be implemented in a variety of software and programming languages, including without limitation hypertext markup language (“HTML”), Java, C, C++, XML, and others as understood by those skilled in the art.

As illustrated in FIGS. 5 and 11, embodiments of the present invention can include, for example, a card 50, e.g., a prepaid card, and a card reader device 541 associated with a retailer 540. As understood by those skilled in the art, a prepaid card 50 can have indicia 52, e.g., logos, slogans, source identifiers, of a financial institution, i.e., a sponsoring bank and of a prepaid card processor; a serial number 54; and expiration date 56. The structures of various types of specific cards, e.g., magnetic stripe 58, type of material, are well known to those skilled in the art and can be used with embodiments of the present invention. Typically, a pre-paid card 50 is formed from plastic and has a magnetic stripe 58 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed. The magnetic stripe card 50 can store information, or data, e.g., account information, by modifying the magnetism of particles on the magnetic stripe 58 on the card. The information can be read by swiping the card through a slot 544 past a reading head of a card reader device 541. The card reader device 541 can include a display 542 and input/output (I/O) devices 543, e.g., a keypad. The card reader device 541 can be associated with a computer 545, e.g., cash register or point-of-sale, having, for example, memory 548, such as, computer readable media; one or more processors 547; and input-output I/O devices 546. Typically, there are two tracks of information on a magnetic card 50 used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN. The information, e.g., data, on the card can be used, for example, to facilitate a transaction. For example, when the card 50 is swiped through a slot 544, the data on the magnetic stripe 58 is read and processed by the card reader 541, converting data stored in the magnetic particles on the card into data associated with readers 541 and a bank computer 502. The card reader 541 and associated computer 545 can then communicate through an electronic communications network 551 to, for example, a pre-paid card processor computer 532. The card reader 541 communicates the account information, e.g., data, as read from the card, as well as other data, such as, an amount of a proposed transaction for approval from the computer 545, e.g., point-of-sale terminal. The other data, for example, can be entered by retailer personnel (e.g., an amount of the transaction), the consumer (e.g., a PIN, or security code), or pre-paid card processor personnel (e.g., a security approval). The pre-paid card processor computer 532 can then utilize the account information and other data to authorize or reject a purchase by, for example, determining whether a proposed purchase by the consumer is less than an amount of funds remaining on the card. Moreover, optional security measures, including, for example, a mismatch between a PIN supplied by the consumer and a PIN stored on the card or in a database, can result in the rejection of a proposed transaction. The pre-paid card processor computer 532 then perform certain functions, including responding to the authorization request so that a point of sale displays an indication of approval or rejection, resulting in a visual depiction to a merchant of the approval or rejection of the proposed transaction. Also, pre-paid card processor computer 532 can, for example, write data to a database to record a purchase or other transaction, to debit available funds from an account associated with the pre-paid card 537, and to credit directly or indirectly a retailer 540 for a purchase. In addition to purchase authorization, embodiments of the present invention also can include customer inquiries into recent transactions or a balance inquiry, i.e., an amount of remaining value associated with the pre-paid card.

As illustrated in FIGS. 5 and 13, embodiments of the present invention include, for example, a computer system for loading loan proceeds to a pre-paid card. The computer can be associated with a pre-paid card processor 531 and configured as a pre-paid card processor computer 532, 951. The pre-paid card processor computer 532, 951 can be in communication through an electronic communications network 551 with a bank computer 502 positioned to pend and then credit loan proceeds for a pre-paid card 50. The pre-paid card processor computer can include a processor 535 positioned to activate a pre-paid card responsive to a request on behalf of a borrower, to transmit a notice of an activation of the pre-paid card to the bank computer, and to load pending loan proceeds to a pre-paid card. The pre-paid card processor computer can include an input/output unit 536 for transferring data between the processor 535 and the bank computer 502. The pre-paid card processor computer can also include a memory 534 having stored therein program product 538, stored on a tangible computer memory media and operable on the processor. The program product includes a set of instructions 955 that, when executed by the processor, cause the computer to load loan proceeds to a pre-paid card by performing various the operations. The operations can include, for example, activating by the pre-paid card processor computer a pre-paid card responsive to an activation request on behalf of a borrower 957. The operations can include, for example, transmitting to the bank computer by the pre-paid card processor computer notice of an activation of a pre-paid card associated with the pre-paid card processor responsive to an activation of the pre-paid card 959. The operations can include, for example, loading pending loan proceeds by the pre-paid card processor computer to a prepaid card by changing a physical structure of the pre-paid card to reflect a presence of funds sufficient up to a specified amount for purchase of goods or services responsive to the bank computer crediting the pending loan proceeds to the pre-paid card processor computer for the activated pre-paid card so that the loan proceeds are released to the approved borrower and are immediately available to thereby convert the pre-paid card into a loan delivery apparatus 961. Embodiments further include computer system wherein the activation request on behalf of the borrower includes an indication that the activation request is responsive to a pending loan.

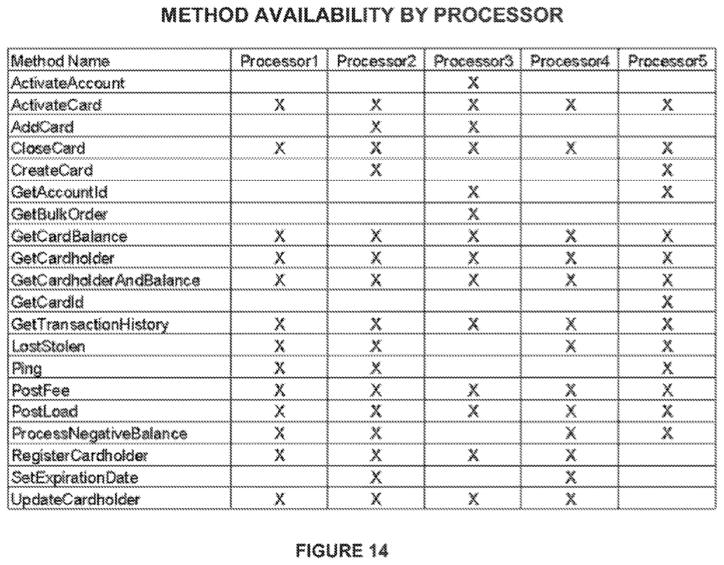

Applicant has identified that the different interfaces of the existing prepaid card processors, as illustrated in FIG. 14, are a source of problems with advancing loan proceeds on prepaid cards. Note that no two prepaid card processors provide the same method availability, and that no prepaid card processor supports every method. Collectively, the various interfaces add complexity, needlessly limit the ability of a lender to make loans available to customers with prepaid cards, increase the error rate for such loan processing, and result in higher training costs for loans associated with prepaid card accounts. Embodiments of the present invention provide a solution to these problems in the context for advancing loan proceeds to a prepaid card.

Embodiments of the present invention include generating a common interface for loan information when proceeds from the loan are destined for a prepaid card account. As understood by a person having ordinary skill in the art, the common interface of the embodiments of the present invention is agnostic to the prepaid card processor. That is, the common interface works with a plurality of prepaid card processors, including but not limited to, for example, FDR, FSV, Galileo, Symmetrex, and TSYS prepaid card processors, for example, as understood by those skilled in the art. First Data Corporation, formerly First Data Resources, (FDR) is a transaction processing company, including prepaid cards, and is headquartered in Greenwood Village, Colorado, as understood by those skilled in the art. FSV Payment Systems, Inc. (FSV) provides prepaid technology and stored value processing and is headquartered in Houston, Texas, as understood by those skilled in the art. Galileo Processing, Inc. (Galileo) is a privately held, financial payment processing company based out of Salt Lake City, Utah, as understood by those skilled in the art. Symmetrex, Inc. (Symmetrex) is a transaction processing company and a large prepaid card processor in the United States, located in Maitland, Fla., as understood by those skilled in the art. With headquarters located in Columbus, Ga., Total System Services, Inc. (TSYS) provides electronic payment services to financial institutions and companies, including consumer—finance, credit, debit, healthcare, loyalty, prepaid, chip and mobile payments, as understood by those skilled in the art.

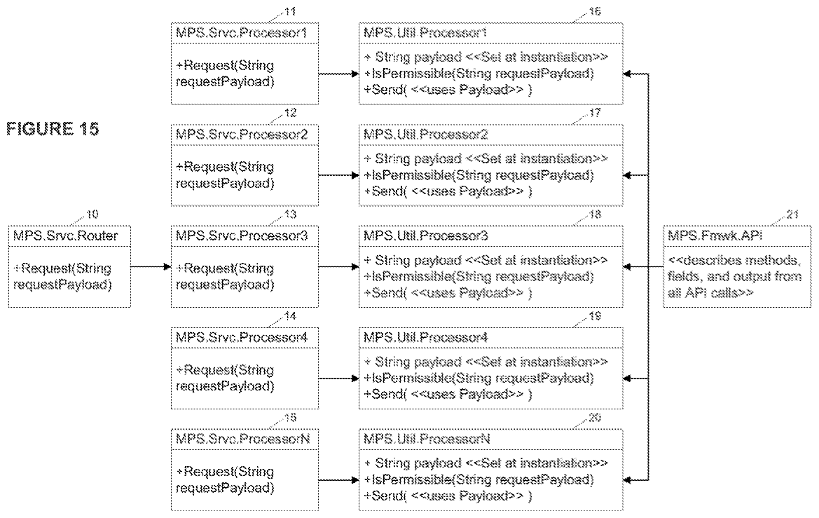

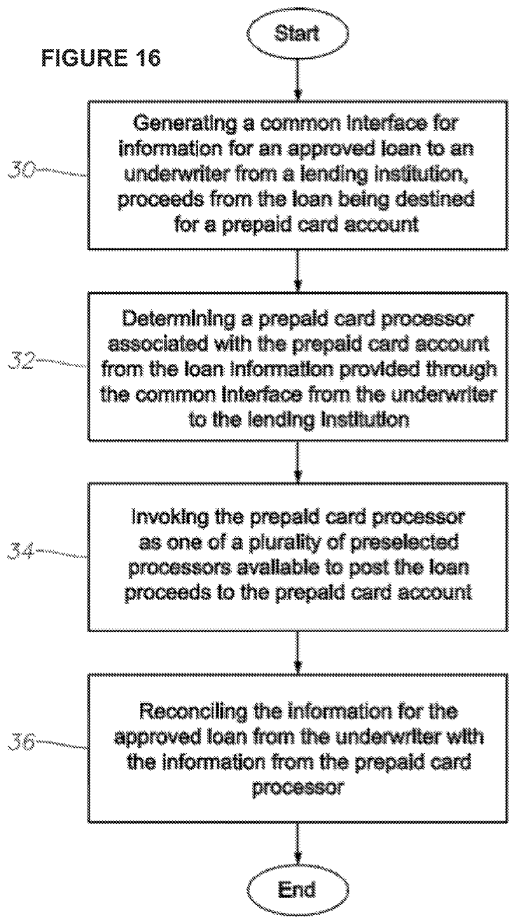

In an exemplary embodiment of the present invention, the common interface is generated by a computer program product running on a computer associated with a lending institution. The lending institution computer acts a gateway between the computer of the underwriter and the prepaid card processor. Under the ‘forwarder’ software architecture for the services provided, as illustrated in FIG. 15, the lending institution computer forwards loan information from the underwriter computer to the prepaid card processors, keeping the entry point of information the same while differentiating the processor-specific implementations. Separation of the processor-specific implementation or resources allows for client software, for example, client software associated with the underwriter computer, to remain agnostic to the eventual endpoint. In this exemplary embodiment of the present invention, the gateway contains a single ‘Request’ method, or request, accepting an XML payload. As understood by one skilled in the art, the payload contains a section for message content, a section for a description of the message content, and a section for exception information pertaining to the message. In this exemplary embodiment, the processor servicing gateways are further broken out to utility libraries to maintain a loosely coupled relationship with SOAP and processor implementations. Utilities maintain ‘rules’ and ‘definitions’ within a framework defining the calls, methods, inputs, outputs, and basic entity models, as shown in 21. MPS.Srvc.Router 10 provides the common interface. MPS.Srvc.«processorName» 11-15 provide gateway functionality to the prepaid card processor. MPS.Util.«processorName» 16-20 provide the processor-specific implementation. As understood by those having skill in the art, there are numerous ways and variations for implementing the present invention.

Embodiments of the present invention include a computer-implemented method of advancing loan proceeds on a prepaid card, as illustrated in FIG. 16. Under the computer-implemented method, a lending institution computer generates a common interface for information for an approved loan to an underwriter computer for loans when proceeds from the loan are destined for a prepaid card account (block 30). After approving the customer's loan request, the underwriter computer provides loan information through the common interface to the lending institution computer. Because of the common interface, the information provided is agnostic to the prepaid card processor to be used. Next, the lending institution computer determines a prepaid card processor associated with the prepaid card account from the loan information provided through the common interface (block 32). Having determined the appropriate prepaid card processor, the bank computer invokes the prepaid card processor as one of a plurality of preselected processors available to post the loan proceeds to the prepaid card account (block 34). Once the loan proceeds are posted, the borrower has access to the proceeds through the prepaid card. The computer-implemented method further includes the bank computer reconciling the information for the approved loan from the underwriter with the information from the prepaid card processor (block 36).

Reconciling the information for the approved loan from the underwriter computer with the information from the prepaid card processor is a form of error-checking for the entire process. For example, if the underwriter computer indicates an approved loan of certain amount destined for a prepaid card account and the prepaid card processor indicates a posting of that certain amount at the same date and near the same time, then reconciling the information provides confirmation of success; there is no error. However, in another example, if the underwriter computer indicates an approved loan of certain amount destined for a prepaid card account and the prepaid card processor indicates a posting of a different amount at the same date and near the same time, then reconciling the information provides an error, in this case of the amount. As understood by those skilled in the art, a bank computer reconciling the information for the approved loan from the underwriter computer with the information from the prepaid card processor can provide numerous and different types of errors.

Embodiments of the present invention further include the selling the loan obligations by the lending institution, as understood by one skilled in the art. For example, the lending institution computer can bundle or package the loan obligations so that the lending institution can provide more loans than its lending capacity, as determined by regulations and as understood by those skilled in the art.

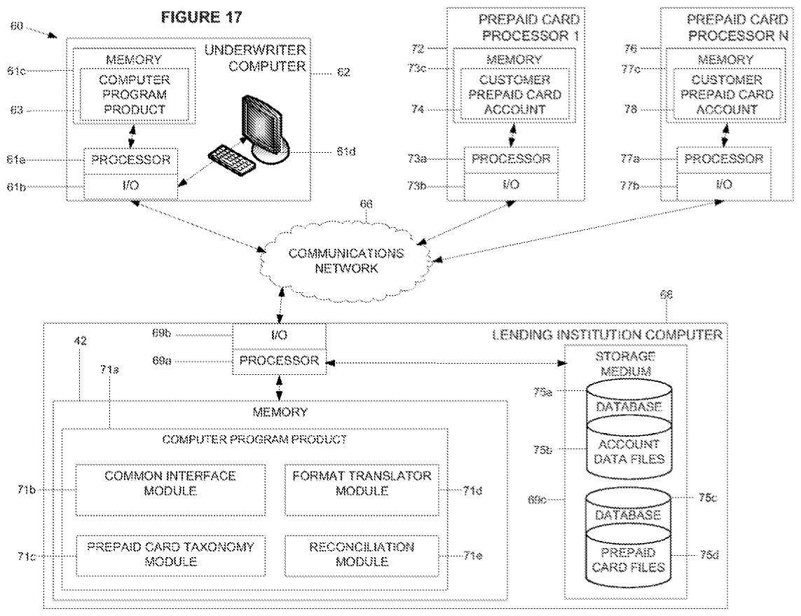

Embodiments of the present invention also provide a system a system 60 to advance loan proceeds on a prepaid card, as illustrated in FIG. 17. The system 60 includes a first computer associated with an underwriter defining an underwriter computer 62. The underwriter computer can have one or more processors 61a, input/output (1/0) devices 61b, memory 61c, and an optional display 61d. The memory 61c of the underwriter computer 62 can include computer program products 63 associated with receiving and approving a loan application. The underwriter computer 62 can provide information for a loan, or loan data, through an electronic communications network 66 to a second computer associated with a lending institution defining a bank computer 68. That is, the underwriter computer 62 determines whether to approve a loan responsive to the loan application and sends the approved loan information to the bank computer 68. The bank computer 68 can have one or more processors 69a, input/output (I/O) devices 69b, memory 42, an optional display, and storage media 69c. The bank computer 68 receives and processes loan information from the underwriter computer 62 utilizing a computer program product 71a described herein. The system 60 also includes a plurality of third computers associated with customer prepaid card accounts 74, 78 defining prepaid card processors 72, 76. The prepaid card processors 72, 76 can each have one or more processors 73a, 77a, input/output (1/0) devices 73b, 77b, and memory 73c, 77c. The prepaid card processors 72, 76 receive posting information from the bank computer 68 through the electronic communications network 66 and, responsive to a post, credit loan proceeds to a prepaid card account 74, 78.

Note that although specification describes and illustrates the underwriter and the lending institution as distinct and separate entities, those skilled in the art recognize that the underwriter and the lending institution may be the same entity and that the underwriter computer 62 may be the same as the bank computer 68. That is, whether the underwriting functionality is performed “in-house” at the lending institution, or otherwise, is not a limitation of the present invention, as understood by those skilled in the art.

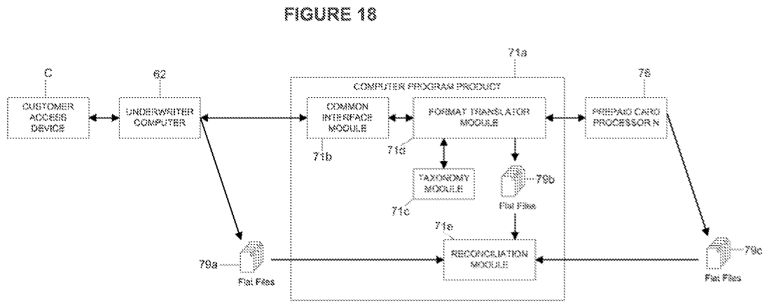

The embodiments of the present invention also include a computer program product 71a, as illustrated in FIGS. 17 and 18, associated with the bank computer 68, stored on a tangible computer memory media 42, operable on a computer, and used to advance loan proceeds to a prepaid card account 74, 78. The computer program product 71a can include various modules, or components, where each module is associated with a computer, stored on a tangible computer memory media and operable on a computer, and includes a set of instructions that, when executed by the computer, cause the computer to perform various operations. For example, the computer program product 71a can include a common interface module 71b associated with the bank computer 68, stored on a tangible computer memory media and operable on a computer; the common interface module can include a set of instructions that, when executed by the computer, cause the computer to perform the operation of receiving data for an approved loan from one or more underwriter computers 62, where the proceeds from the loan are destined for a prepaid card account 74, 78. The computer program product 71a can include, for example, a prepaid card taxonomy module 71c associated with the bank computer 68, stored on a tangible computer memory media and operable on a computer. The prepaid card taxonomy module 71c can include a set of instructions that, when executed by the computer, cause the computer to classify prepaid cards according to an associated prepaid card processor, to maintain and manage a database 75c of prepaid card files 75d that associates prepaid cards with prepaid card processors, and to determine a prepaid card processor associated with the prepaid card account from loan data provided through the common interface module 71b from the underwriter computer 62 responsive to a prepaid card serial number. The computer program product 71a can include, for example, a format translator module 71d associated with the bank computer 68, stored on a tangible computer memory media and operable on a computer. The format translator module 71d can include a set of instructions that, when executed by the computer, cause the computer to invoke the associated prepaid card processor 76 for a given prepaid card responsive to the determination of the taxonomy module 71c, to convert the loan data received by the common interface module 71b into a processor-specific instruction format, and to communicate the converted loan data to the prepaid card processor 76 to post the loan proceeds to the prepaid card account 78 so that a first data format is converted into a second data format to thereby enable the posting of the loan proceeds to the prepaid card and so that the loan application is converted into a prepaid card having an associated value and being capable of purchasing goods. The computer program product 71a can include, for example, a reconciliation module 71e associated with the bank computer 68, stored on a tangible computer memory media and operable on a computer. The reconciliation module 71e can include a set of instructions that, when executed by the computer, cause the computer to receive and compare data for the approved loan, e.g., flat files 79a, 79b, 79c, or data files that have no structural relationship as understood by those skilled in the art, from the underwriter computer 62, from the prepaid card processor 76, and the format translator module 71d. The reconciliation module can, for example, converts the flat file data into structured database files to thereby reconcile the data and check for errors. In addition, the reconciliation module can, for example, produce error reports responsive to a comparison of the structured database files. See also FIG. 18 for data flow between the various modules according to an embodiment of the present invention.

A serial number of a prepaid card can include, for example, a Bank Identification Number (BIN) as understood by those skilled in the art. Each card number issued within an open payment network, such as, Visa, MasterCard, and others as understood by those skilled in the art, includes a Bank Identification Number. Each Bank Identification Number is assigned to an issuer, i.e., a lending institution, by the open payment network as understood by those skilled in the art. When the Bank Identification Number is configured with the open payment network, the prepaid card processor, or the destination for authorization and settlement transactions, is designate by the issuer, i.e., the lending institution, as understood by those skilled in the art. According to embodiments of the present invention, the prepaid card taxonomy module 71c can utilize the Bank Identification Number portion of the serial number of a prepaid card to determine the prepaid card processor.

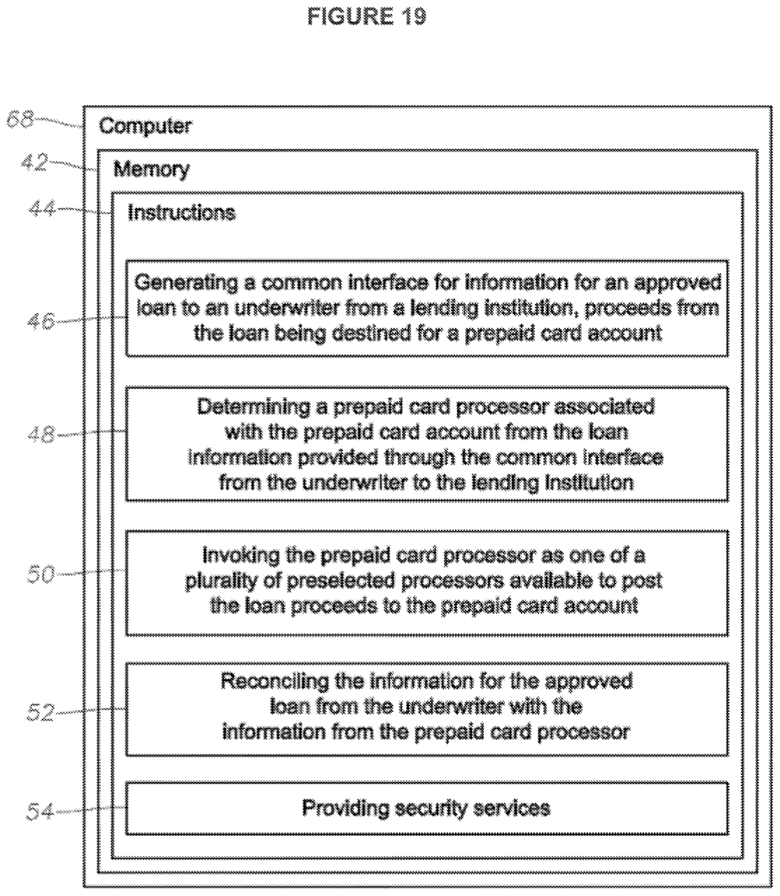

The embodiments of the present invention also include a computer program product, as illustrated in FIG. 19, associated with the bank computer 68, stored on a tangible computer memory media 42, operable on a computer 68, the computer program product comprising a set of instructions 44 that, when executed by the computer, cause the computer to perform various operations. The operations include generating a common interface for information for an approved loan to an underwriter computer from the bank computer when proceeds from the loan are destined for a prepaid card account (block 46). The operations also include determining a prepaid card processor associated with the prepaid card account from the loan information provided through the common interface from the underwriter to the lending institution (block 48). The operations further include invoking the prepaid card processor as one of a plurality of preselected processors available to post the loan proceeds to the prepaid card account (block 50). The operations also include reconciling the information for the approved loan from the underwriter computer with the information from the prepaid card processor (block 52). The operations further include providing security services (block 54), such as permitting only known and verified computer addresses, requiring user name and password, and other such application-level and firewall-level functions, as understood by those skilled in the art.

This application is a continuation-in-part of and claims priority to and the benefit of U.S. Non-Provisional patent application Ser. No. 13/941,530, by Galit et al, titled “System, Program Product, and Method for Loading a Loan on a Pre-Paid Card,” filed Jul. 14, 2013, which is a continuation of and claims priority to and the benefit of: U.S. Non-Provisional patent application Ser. No. 12/465,306, by Galit et al., titled “System, Program Product, and Method for Loading a Loan on a Pre-Paid Card” filed May 13, 2009, which claims priority to and the benefit of: U.S. Provisional Patent Application Ser. No. 61/053,056, by Galit et al., titled “System, Program Product, and Method for Loading a Loan on a Pre-Paid Card” filed May 14, 2008; U.S. Provisional Patent Application Ser. No. 61/060,559, by Galit et al., titled “Methods, Program Product, and System to Enhance Banking Terms Over Time” filed on Jun. 11, 2008; and U.S. Provisional Patent Application Ser. No. 61/082,863, by Ahlers et al., titled “System, Program Product, and Method For Debit Card and Checking Account Autodraw” filed on Jul. 23, 2008. The contents of U.S. Non-Provisional patent application Ser. Nos. 13/941,530 and 12/465,306 and U.S. Provisional Patent Application Ser. Nos. 61/053,056, 61/060,559, and 61/082,863 are each incorporated herein by reference in their entireties. This application also relates to: U.S. Provisional Patent Application Ser. No. 61/016,213, by Sorbe et al., titled “Transfer Account Systems, Computer Program Products, and Associated Methods” filed on Dec. 21, 2007; U.S. Provisional Patent Application Ser. No. 61/052,454, by Sorbe et al., titled “Transfer Account Systems, Computer Program Products, and Methods to Prioritize Payments from Preselected Bank Account” filed May 12, 2008; U.S. Provisional Patent Application Ser. No. 61/029,975, by Sorbe et al., titled “Methods To Advance Loan Proceeds On Prepaid Cards, Associated Systems and Computer Program Products” filed on Feb. 20, 2008; U.S. Provisional Patent Application Ser. No. 61/042,612, by Ahlers et al., titled “System, Program Product, and Associated Methods to Authorize Draw for Micro-Credit Attached to a Prepaid Card” filed on Apr. 4, 2008; U.S. Provisional Patent Application Ser. No. 61/042,624, by Crowe et al., titled “System, Program Product, and Method to Authorize Draw for Retailer Optimization” filed on Apr. 4, 2008; U.S. Provisional Patent Application Ser. No. 61/032,750, by Ahlers et al., titled “Methods, Program Product, and System for Micro-Loan Management” filed on Feb. 29, 2008, all of which are each incorporated herein by reference in their entireties. This application also relates to: U.S. patent application Ser. No. 12/338,365, by Sorbe et al., titled “Transfer Account Systems, Computer Program Products, and Associated Computer-Implemented Methods” filed on Dec. 18, 2008; U.S. patent application Ser. No. 12/338,402, by Sorbe et al., titled “Transfer Account Systems, Computer Program Products, and Associated Computer-Implemented Methods” filed on Dec. 18, 2008; U.S. patent application Ser. No. 12/338,440, by Sorbe et al., titled “Transfer Account Systems, Computer Program Products, and Associated Computer-Implemented Methods” filed on Dec. 18, 2008; U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008; U.S. patent application Ser. No. 12/389,749, by Sorbe et al., titled “Methods to Advance Loan Proceeds on Prepaid Cards, Associated Systems and Computer Program Products” filed on Feb. 20, 2009; PCT/US09/34692, by Sorbe et al., titled “Methods to Advance Loan Proceeds on Prepaid Cards, Associated Systems and Computer Program Products” filed on Feb. 20, 2009; U.S. patent application Ser. No. 12/417,199, by Ahlers et al., titled “System, Program Product, and Associated Methods to Authorize Draw for Micro-Credit Attached to a Prepaid Card” filed on Apr. 2, 2009; U.S. patent application Ser. No. 12/417,211, by Ahlers et al., titled “System, Program Product, and Associated Methods to Authorize Draw for Micro-Credit Attached to a Prepaid Card” filed on Apr. 2, 2009; PCT/US09/39492, by Ahlers et al., titled “System, Program Product, and Associated Methods to Authorize Draw for Micro-Credit Attached to a Prepaid Card” filed on Apr. 3, 2009; PCT/US09/39504, by Ahlers et al., titled “System, Program Product, and Associated Methods to Authorize Draw for Micro-Credit Attached to a Prepaid Card” filed on Apr. 3, 2009; U.S. patent application Ser. No. 12/417,182, by Crowe et al., titled “System, Program Product, and Method to Authorize Draw for Retailer Optimization” filed on Apr. 2, 2009; PCT/US09/39512, by Crowe et al., titled “System, Program Product, and Method to Authorize Draw for Retailer Optimization” filed on Apr. 3, 2009; U.S. patent application Ser. No. 12/338,684, by Ahlers et al., titled “Computer-Implemented Methods, Program Product, and System for Micro-Loan Management” filed on Dec. 18, 2008; PCT/US08/87660 by Ahlers et al., titled “Computer-Implemented Methods, Program Product, and System for Micro-Loan Management” filed on Dec. 19, 2008; U.S. patent application Ser. No. 12/338,712, by Galit et al., titled “Computer-Implemented Methods, Program Product, and System to Enhance Banking Terms Over Time” filed on Dec. 18, 2008; PCT/US08/87689 by Galit et al., titled “Computer-Implemented Methods, Program Product, and System to Enhance Banking Terms Over Time” filed on Dec. 19, 2008; U.S. patent application Ser. No. 12/417,162, by Ahlers et al., titled “System, Program Product, and Method For Debit Card and Checking Account Autodraw” filed on Apr. 3, 2009; PCT/US09/39495, by Ahlers et al., titled “System, Program Product, and Method For Debit Card and Checking Account Autodraw” filed on Apr. 3, 2009; and U.S. patent application Ser. No. 12/465,277, by Galit et al., titled “System, Program Product, and Computer-Implemented Method for Loading a Loan on a Pre-Paid Card” filed on May 13, 2009, all of which are each incorporated herein by reference in their entireties.

A person having ordinary skill in the art will recognize that various types of memory are media readable by a computer such as described herein, e.g., borrower computer, lender computer, bank computer, pre-paid card processor computer, retailer computer, point-of-sale terminal, payroll processor, or other computers with embodiments of the present invention. Examples of tangible computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood by those skilled in the art that such media can be at other locations instead of or in addition to the bank computer to store program products, e.g., including software, thereon. A person having ordinary skill in the art will recognize that various types of computers and computer architectures, including, for example, distributed computing, cloud computing, data centers, mobile and handheld devices, and other systems, are embodiments of the present invention, and these embodiments are intended to be included within the scope of the appended claims. That is, the lender computer, bank computer, pre-paid card processor computer, for example, can be implemented through a distributed computing environment. Likewise, a borrower computer, for example, can be a personal digital assistant (PDA) or a mobile telephone.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That is claimed is:

1. A computer-implemented method to facilitate the funding of a loan from a lender to an existing prepaid card account associated with one of a plurality of prepaid card processors and to cause one or more bank fees to be charged to the lender, the computer-implemented method comprising:
creating via one or more computers, associated with a bank and defining a bank computer, a loan proceeds account to receive loan proceeds from the lender computer responsive to receipt of loan authorization data from the lender computer, the loan authorization data including a lender authorized amount and a request to transfer the loan proceeds to an existing prepaid card account number associated with a borrower,
crediting, via the bank computer, the lender authorized amount to the loan proceeds account,
generating, via the bank computer, a request to verify the existing prepaid card account number in the preselected communication protocol of the one of the plurality of prepaid card processor computers, thereby allowing the request to be processed by the one of the plurality of prepaid card processor computers,
sending, via the bank computer, the request to the one of the plurality of prepaid card processor computers to thereby communicate in the preselected communication protocol of the one of the plurality of prepaid card processor computers,
deducting, via the bank computer, one or more bank fees from the lender authorized amount responsive to receipt of verification of the existing prepaid card account number, and
communicating, via the bank computer and responsive to the deducting step, loan funding data to the one of the plurality of prepaid card processors using the preselected communication protocol to thereby release the loan proceeds amount to the one of the plurality of prepaid card processor computers so that the loan proceeds amount becomes immediately available to the borrower to thereby facilitate the funding of the loan from the lender to the existing prepaid card account.

2. A computer-implemented method as defined in claim 1, wherein the loan proceeds amount is available to the borrower through the existing prepaid card account after a delay of one-half of one second to one minute after the bank computer receives the loan authorization data from the lender computer.

3. A computer-implemented method as defined in claim 1, wherein the computer-implemented method further comprises:
querying the plurality of prepaid card processor computers to determine which of the plurality of prepaid card processor computers maintains the existing prepaid card account.

4. A computer-implemented method as defined in claim 1, wherein the loan authorization data includes prepaid card processor identification data that indicates which of the plurality of prepaid card processor computers maintains the existing prepaid card account.

5. A computer-implemented method as defined in claim 1, wherein the computer-implemented method further comprises:
determining the preselected communication protocol of the one of the plurality of prepaid card processor computers using the prepaid card processor identification data in the loan authorization data.
